(19) United States
(12) Patent Application Publication
(10) Pub. No.: US 2026/0124975 A1
(43) Pub. Date: May 7, 2026

(54) Connected Attachable and Detachable Seat Cover and Case

(71) Applicant: Ayanna Maharry, Los Angeles, CA (US)

(72) Inventor: Ayanna Maharry, Los Angeles, CA (US)

(21) Appl. No.: 19/381,120

(22) Filed: Nov. 6, 2025

Related U.S. Application Data
(60) Provisional application No. 63/716,250, filed on Nov. 5, 2024.

(51) Int. Cl. B60N 2/60

(52) U.S. Cl. CPC B60N 2/6018

(57) ABSTRACT

The technical innovation of this invention allows the user to reap the benefit of using a seat cover on the upholstery of their vehicle, but also the benefit of being able to discretely tuck the seat cover away when it is not in use.

### CROSS-REFERENCE TO RELATED APPLICATIONS

This nonprovisional utility patent application claims the benefit of a prior-filed provisional patent application. Reference to said provisional patent is made under this section heading an also in the application data sheet. Provisional Patent Application No. 63/716,250

### STATEMENT REGARDING FEDERALLY SPONSORED RESEARCH OR DEVELOPMENT

Not applicable.

### REFERENCE TO A SEQUENCE LISTING, A LARGE TABLE, OR A COMUPTER PROGRAM LISTING APPENDIX ON READ-ONLY OPTICAL DISC

Not applicable.

### BACKGROUND OF THE INVENTION

Automobile owners love their cars, trucks, and SUVs and they go to great lengths to maintain and protect the automobile's exterior and interior, including the upholstery. However, there are many forces working against their efforts: bodies drenched in sweat after a hard workout, children and teenagers dirty from head to toe after all-day fun at the playground or a sporting event, dirty dogs in need of a visit to the groomer. The athletes, children, and dogs are transported in automobiles by owners who want to protect their upholstery. Sweat leaves unsightly white “salt” marks and stains on the surface of the upholstery and seeps deep into the leather or fabric. Regardless of how much detailing or cleaning, the damage is done and has short term and long-term effects on the upholstery and the value of the automobile.

These car owners could drape a random towel over their seats, but the towel would likely not be big enough to cover the entire seat and, especially with leather upholstery, would likely slide off before the owner had a chance to sit on it.

The car owner could use a large, bulky binder clip to hold the towel in place, but not only is the binder clip an eye sore, but it pulls the towel and reduces coverage of the towel on the seat. The car owner could use a traditional car seat cover with elastic around it that stretches and covers the entire seat, but for car owners who value the look of their upholstery and don't like the look of seat covers, this is not an option. Also, they do not want the inconvenience of having to continuously remove and re-attach the seat cover, or the inconvenience of having to keep track of where they put it when it is removed.

Drivers who love their cars, but don't want the ugly towel or inconvenient traditional seat cover option, need an effective alternative seat cover option.

### BRIEF SUMMARY OF THE INVENTION

The inventor of the Connected Attachable and Detachable Seat Cover and Case is a car owner and athlete who faced this same problem that many other vehicle owners face, then created the solution that this invention offers.

This invention solves all the aforementioned problem and more, through preventative means. When seeking a product to solve this problem, automobile owners seek certain criteria. This invention meets all these requirements and more (listed below). It is an attractive and convenient system that allows the automobile owner to block sweat, dirt, animal hair, and more. The design of this invention makes it desirable to car owners with new, high-end vehicles, as well as those with older model vehicles.

### CONVENIENCE

Vehicle owners want an option that they can keep conveniently handy. This invention is designed to be kept in the vehicle at all times, making it easily accessible.

### DISCRETE/HIDDEN

Car owners want the covering to be discretely hidden so as not to detract from the elegance of the car's interior. The design of the invention offers a sleek and compact way to store the seat cover when not in use.

### EFFECTIVE/USEFUL

The seat cover fully covers the vehicle seat, helping to retain coverage despite movement from the driver. The lightweight, moisture wicking fabric blocks sweat and allows it to evaporate quickly. It also grabs dirt and animal hair to make for an easy clean-up.

### EASY TO CLEAN

Because of the nature of the problem, the invention must be easy to clean. Vehicle owners need the seat cover to be easy to remove and re-position for cleaning. The attaching mechanism in this invention that connects the seat cover to the case, allows vehicle owners to quickly detach the seat cover from the case for cleaning, then easily re-attach it.

### EASE OF USE

This invention is designed to be quickly and easily used:
1. The system attaches to the vehicle seat via the headrest
2. The seat cover rolls out over the seat
3. The seat cover detaches from and re-attaches to the case for cleaning
4. The seat cover quickly and easily rolls back up and is put back into the case
5. The case is closed

In addition, the entire unit can quickly and easily be detached and re-attached to another seat in the same car, or to a seat in a different car.

### PUBLIC HEALTH

This invention also offers a solution to individuals who travel on airplanes, trains, buses, and other modes of public transportation, and who want a cover to protect them from germs and other possible matter that is likely embedded on seats in public modes of transportation.

### BRIEF DESCRIPTION OF THE SEVERAL VIEWS OF THE DRAWING

Where there are drawings, you must include a listing of all figures by number (e.g., FIG. 1A) and with corresponding statements explaining what each figure depicts.

FIG. 1 This drawing depicts the front of the case.

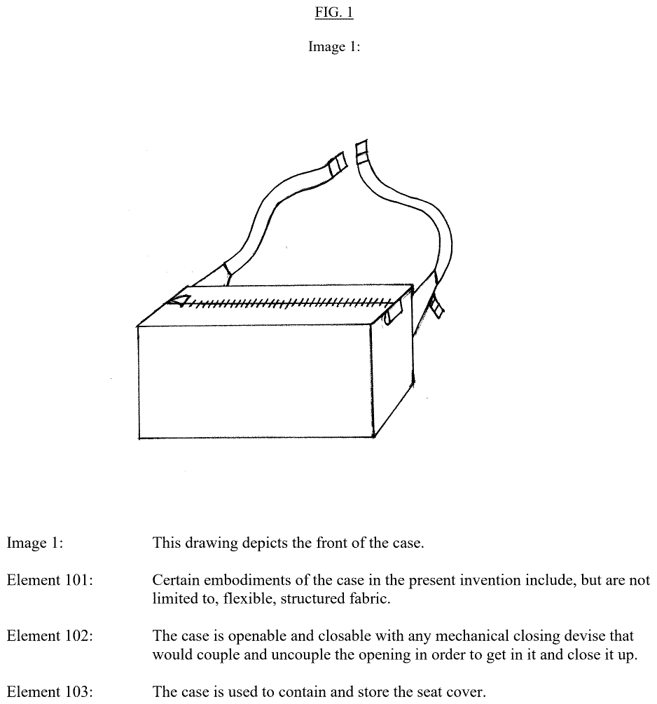

FIG. 2 This image depicts the reverse angle of the image in FIG. 1.

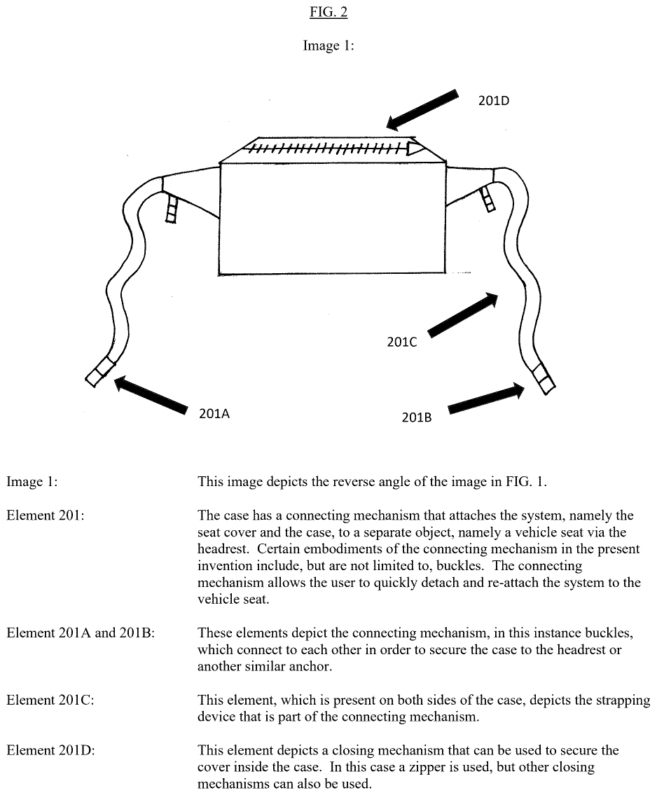

FIG. 3 This image depicts the side angle of the image in FIG. 1.

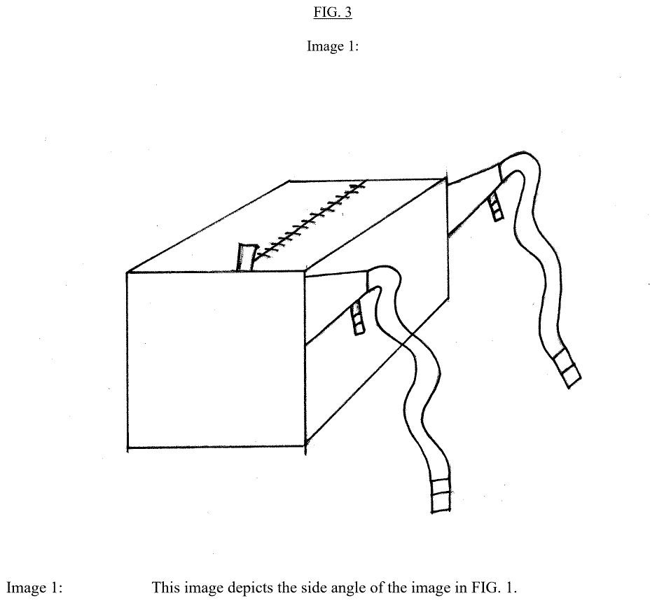

FIG. 4 This image depicts the bottom angle of the image in FIG.

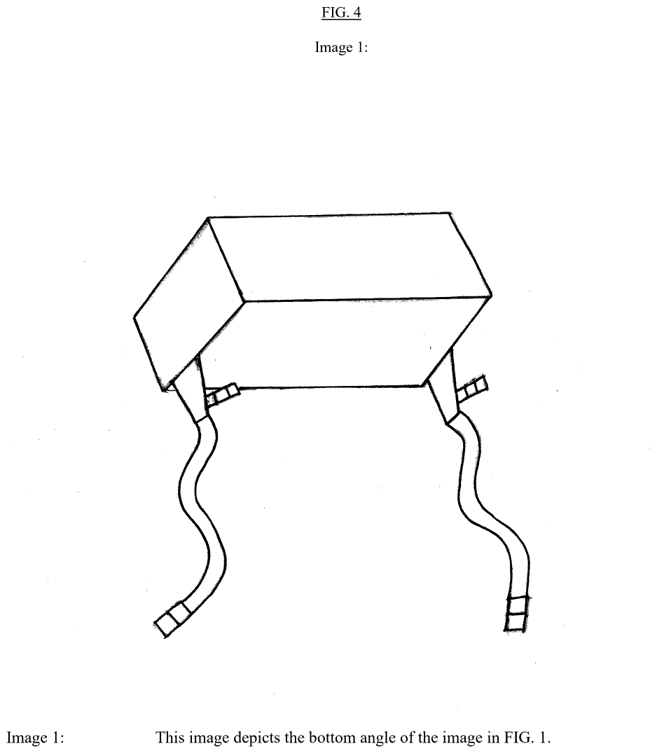

FIG. 5: This is a top view angle of FIG. 1. In this image, the closing mechanism has been opened to reveal a set of attaching mechanisms.

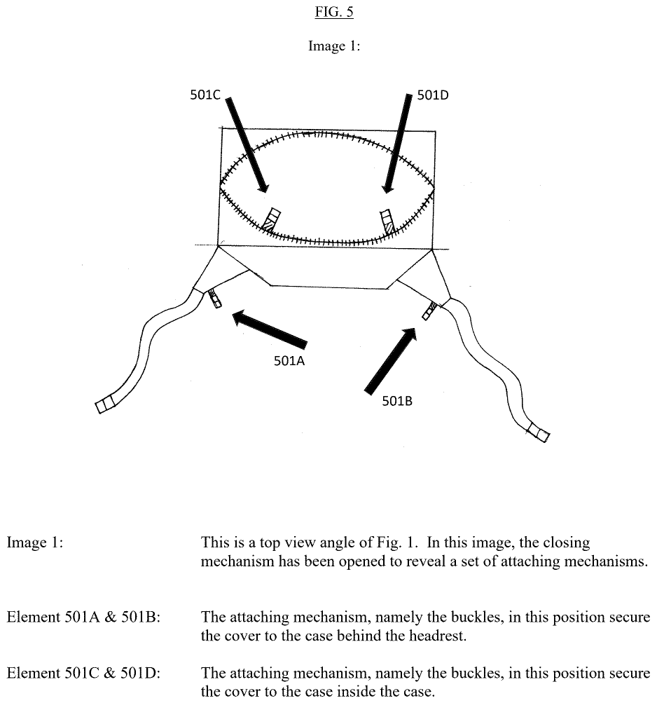

FIG. 6: This image shows the seat cover connected to the case at all connection points. The image also depicts the cover draped over an automobile seat.

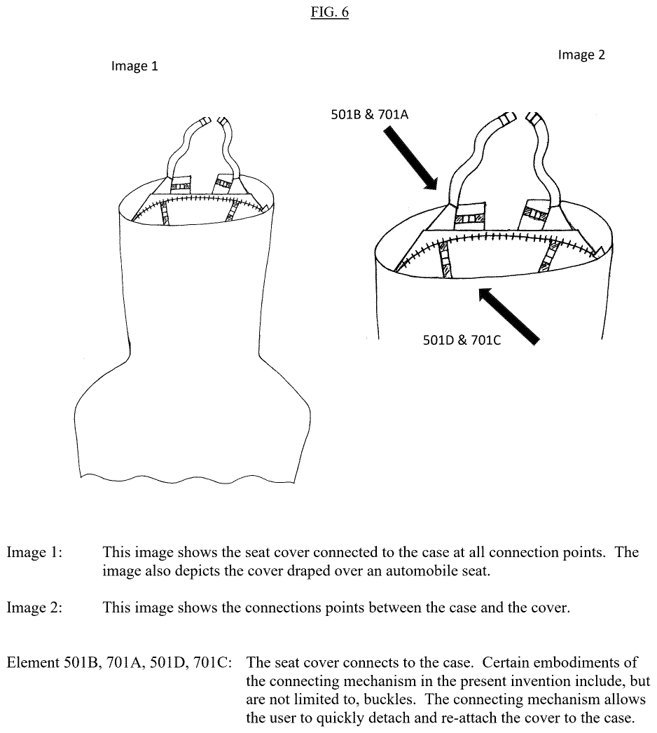

FIG. 7 This image depicts the cover and the connecting mechanisms.

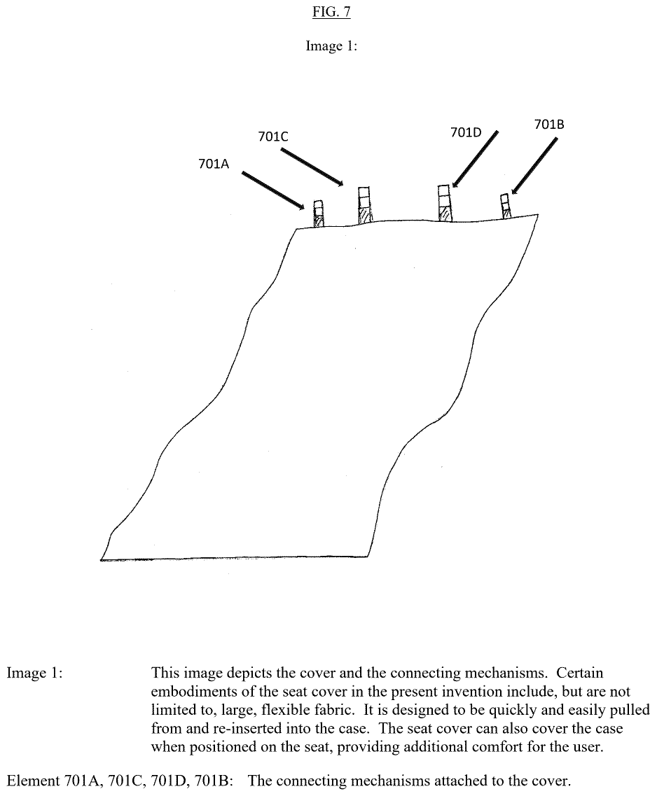

### DETAILED DESCRIPTION OF THE INVENTION

This invention is comprised of a system of a detachable and attachable seat cover and a detachable and attachable case that work in conjunction to solve the stated problem. The system has a connecting mechanism that attaches the seat cover and the case to each other and another connecting mechanism that attaches the entire system to another object, namely a car seat via the headrest.

The manner and process of making and using the invention is as follows:

Using a pre-determined pattern, the case and cover are manufactured by first selecting the fabric, leather, or other suitable material. That material is then cut, per the pattern, into the requisite pieces. Those pieces, along with the zipper, webbing, buckles, and/or piping trim are then sewn together using an industrial sewing machine.

To use the invention in an automobile, the user completes the following steps:
1. The case is attached to the vehicle seat via the headrest
2. The seat cover is pulled out of the case and situated over the seat
3. The cover is further secured by attaching the remaining two connection mechanisms
4. The seat cover detaches from and re-attaches to the case for cleaning
5. The seat cover quickly and easily rolls back up and is put back into the case when not in use
6. The case is closed via the zipper or other closing mechanism

To detach the invention:

To move the invention to another seat or another vehicle, the entire unit can quickly and easily be detached and re-attached using the buckles or other connecting mechanism.

To clean the invention:

As a practical matter, the cover requires consistent cleaning after absorbing sweat and other substances. The cover can be cleaned by quickly and easily detaching the cover from the case at the designated connection mechanisms. The cover can then be cleaned using standard washing and drying machines.

1. The invention is a an apparatus consisting of a two part system of a cover and a case whereby the cover attaches to the case and the case attaches to the interior, headrest, and/or seat of a mode of transportation, which can be, but is not limited to, an automobile, truck, SUV, plane, train, or bus, for the purpose of shielding and protecting the upholstery of the seat of the mode of transportation from sweat, dirt, mud, animal hair, and/or any other substance that could damage the upholstery.
The device can also be used to protect the user from germs and/or other unwanted substances while riding in or on a public mode of transportation. The cover attaches to the case and the case attaches to the mode of transportation.
The cover can be stored in the case when not in use.
The case consists of any material that can be made to create a structure to hold the cover and which can connect to the mode of transportation. This material includes, but is not limited to, leather, nylon fabric, polyester fabric, plastic.
The cover consists of any material that can be made to drape over the seat of the mode of transportation and which can be contained within the case. This material includes, but is not limited to, synthetic and/or natural fabrics such as polyester, nylon, and/or cotton fabrics,
The attachment and detachment mechanisms consists of any mechanism that can be used to connect the case to the cover and the cover to the mode of transportation. These mechanisms include, but are not limited to, parachute buckles, snaps, buttons, elastic, string, Velcro.
The case can be closed using a zipper or other similar mechanism or it can be left open.
